(19) United States
(12) Patent Application Publication
(10) Pub. No.: US 2024/0373504 A1
(43) Pub. Date: Nov. 7, 2024

(54) JOINT CDRX-TWT OPTIMIZATION FOR MOBILE HOTSPOTS

(71) Applicant: Samsung Electronics Co., Ltd., Suwon-si (KR)

(72) Inventors: Anum Ali, Frisco, TX (US); Abhishek Sehgal, Frisco, TX (US); Vutha Va, Plano, TX (US); Boon Loong Ng, Plano, TX (US)

(21) Appl. No.: 18/536,109

(22) Filed: Dec. 11, 2023

Related U.S. Application Data
(60) Provisional application No. 63/464,380, filed on May 5, 2023.

(51) Int. Cl. H04W 76/28; H04W 52/02

(52) U.S. Cl. CPC H04W 76/28; H04W 52/0216

(57) ABSTRACT

A mobile access point (AP) includes a first wireless transceiver configured to transmit and receive traffic with a first mobile station (STA), a second wireless transceiver configured to transmit and receive traffic with a gNB, and a processor operably coupled to the first wireless transceiver and the second wireless transceiver. The processor is configured to route traffic between the first mobile STA and the gNB, and determine, based on a traffic classification operation, a class of the traffic. The processor is further configured to establish, based on the class of the traffic, a Target Wake Time (TWT) agreement between the mobile AP and the first mobile STA. The TWT agreement permits the first wireless transceiver to doze. The processor is further configured to determine, based on the class of the traffic, a continuous mode discontinuous reception (CDRX) configuration for the second wireless transceiver.

### CROSS-REFERENCE TO RELATED APPLICATION AND CLAIM OF PRIORITY

This application claims priority under 35 U.S.C. § 119(e) to U.S. Provisional Patent Application No. 63/464,380 filed on May 5, 2023. The above-identified provisional patent application is hereby incorporated by reference in its entirety.

### TECHNICAL FIELD

This disclosure relates generally to wireless networks. More specifically, this disclosure relates to joint CDRX-TWT optimization for mobile hotspots.

### BACKGROUND

As the popularity of connected devices among consumers increases, consumers are increasingly utilizing standalone mobile hotspot devices and/or utilizing mobile hotspot features from other devices such as smart phones to share mobile data connections with other devices such as tablets, “note pad” computers, net books, eBook readers, and the like that utilize wireless communication. As these mobile hotspot devices are often used in situations where a power source may be unavailable, increased battery life and/or reduced power usage for such mobile hotspot devices is desirable.

### SUMMARY

The present disclosure provides methods and apparatuses for joint CDRX-TWT optimization for mobile hotspots.

In one embodiment, a mobile access point (AP) is provided. The mobile AP includes a first wireless transceiver configured to transmit and receive traffic with a first mobile station (STA), a second wireless transceiver configured to transmit and receive traffic with a gNB, and a processor operably coupled to the first wireless transceiver and the second wireless transceiver. The processor is configured to route traffic between the first mobile STA and the gNB, and determine, based on a traffic classification operation, a class of the traffic. The processor is further configured to establish, based on the class of the traffic, a Target Wake Time (TWT) agreement between the mobile AP and the first mobile STA. The TWT agreement permits the first wireless transceiver to doze. The processor is further configured to determine, based on the class of the traffic, a continuous mode discontinuous reception (CDRX) configuration for the second wireless transceiver.

In another embodiment, a mobile STA is provided. The mobile STA includes a wireless transceiver configured to transmit and receive traffic with a mobile AP, and a processor operably coupled to the wireless transceiver. The processor is configured to establish a TWT agreement between the mobile STA and the mobile AP. The TWT agreement is established based on a class of traffic routed between the mobile STA and a gNB via the mobile AP, and the TWT agreement permits a second wireless transceiver comprised by the mobile AP and configured to transmit and receive traffic with the mobile STA to doze.

In yet another embodiment, a method of operating a mobile AP is provided. The method includes routing traffic between a first mobile STA and a gNB, and establishing, based on the class of the traffic, a TWT agreement between the mobile AP and the first mobile STA. The TWT agreement permits a first wireless transceiver comprised by the mobile AP and configured to transmit and receive traffic with the mobile STA to doze. The method further includes determining, based on the class of the traffic, a continuous mode discontinuous reception (CDRX) configuration for a second wireless transceiver comprised by the mobile AP and configured to transmit and receive traffic with a gNB.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIG. 2 illustrates an example gNB according to embodiments of the present disclosure;

FIG. 3 illustrates an example UE according to embodiments of the present disclosure;

FIG. 4 illustrates an example wireless network according to various embodiments of the present disclosure;

FIG. 5 illustrates an example AP according to various embodiments of the present disclosure;

FIG. 6 illustrates an example STA 411 according to various embodiments of this disclosure;

FIG. 7 illustrates an example of CDRX operation according to various embodiments of this disclosure;

FIG. 8 illustrates an example of IEEE 802.11ax TWT operation according to various embodiments of this disclosure;

FIG. 9 illustrates an example mobile hotspot scenario according to various embodiments of this disclosure;

FIG. 10 illustrates a procedure for joint optimization of CDRX and TWT parameters according to embodiments of the present disclosure;

FIG. 11 illustrates an example of conventional behavior of an AP in a mobile hotspot scenario according to embodiments of the present disclosure;

FIG. 12 illustrates an example of dozing behavior of an AP in a mobile hotspot scenario according to embodiments of the present disclosure;

FIG. 13 illustrates an example process for determining TWT and CDRX parameters based on traffic classification;

FIG. 14 illustrates an example process for determining TWT and CDRX parameters based on traffic classification;

FIG. 15 illustrates an example process for determining TWT and CDRX parameters based on traffic classification;

FIG. 16 illustrates an example process for joint optimization of TWT and CDRX parameters;

FIG. 17 illustrates an example process for joint optimization of TWT and CDRX parameters;

FIG. 18 illustrates an example of CDRX on duration and TWT target wake duration alignment according to embodiments of this disclosure;

FIG. 19 illustrates an example process 1900 for optimizing CDRX on duration and TWT target wake duration alignment; and

FIG. 20 illustrates a method for joint CDRX-TWT optimization for mobile hotspots according to embodiments of the present disclosure.

### DETAILED DESCRIPTION

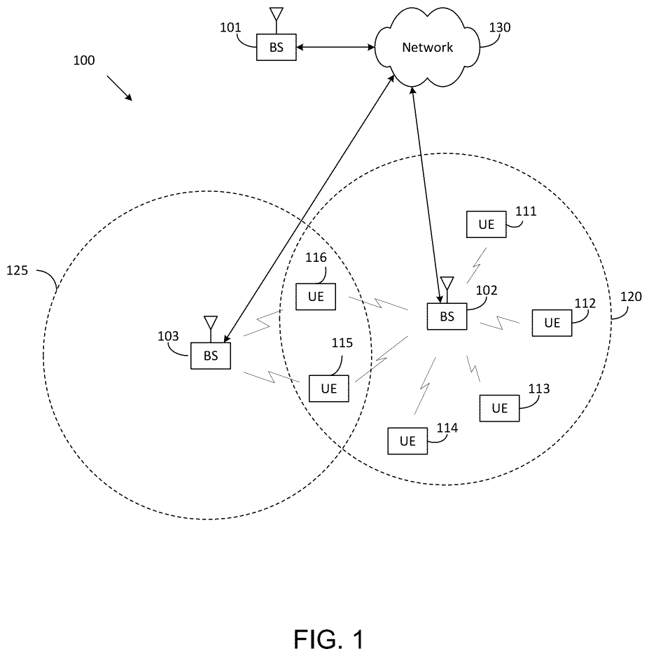

FIGS. 1 through 20, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for joint CDRX-TWT optimization for mobile hotspots. In certain embodiments, one or more of the gNBs 101-103 includes circuitry, programing, or a combination thereof, to support joint CDRX-TWT optimization for mobile hotspots in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

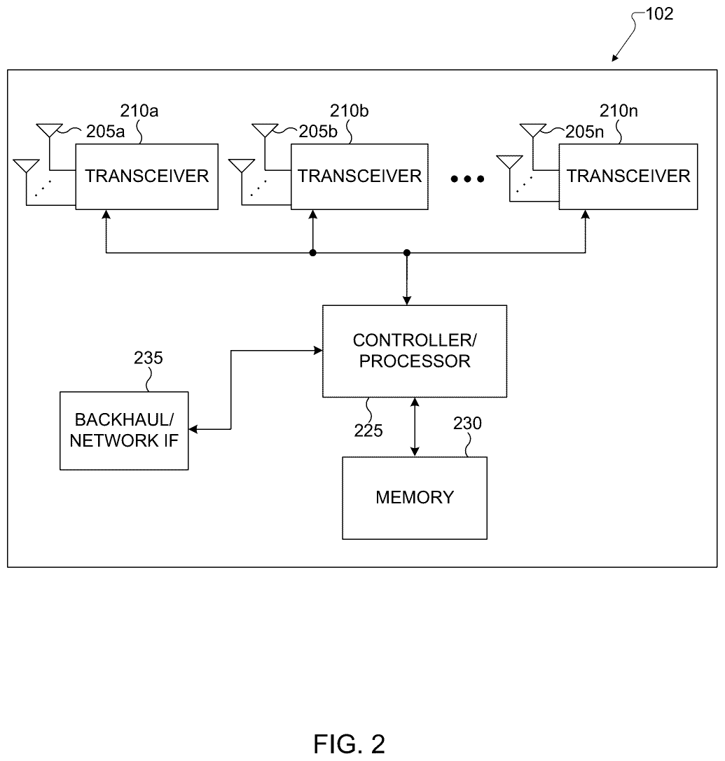

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS and, for example, processes to support a joint CDRX-TWT optimization for mobile hotspots as discussed in greater detail below. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

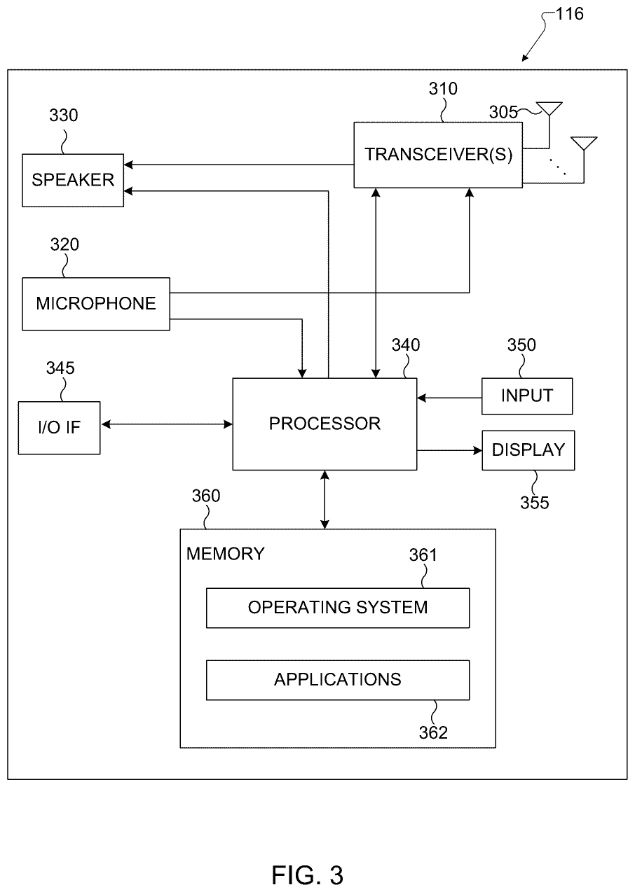

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for a joint CDRX-TWT optimization for mobile hotspots as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

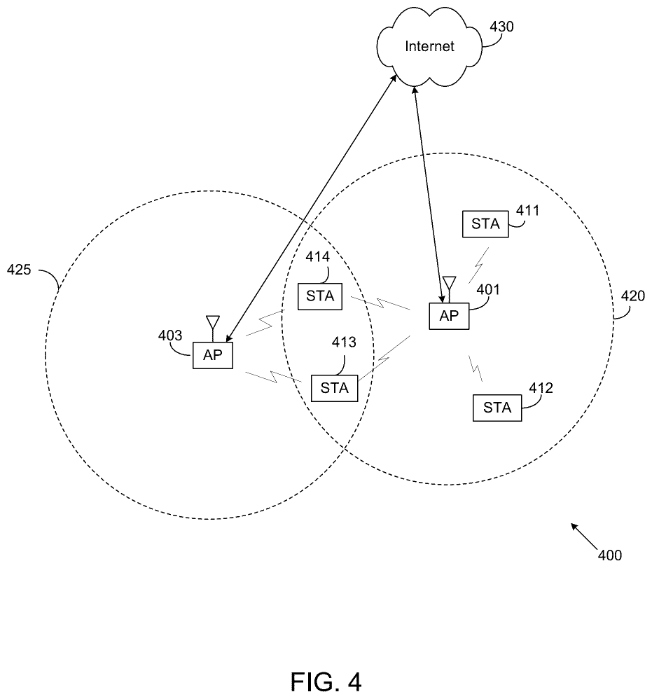

FIGS. 4-6 below describe various embodiments implemented in wireless local area network (WLAN) systems and with the use of Institute of Electrical and Electronic Engineers (IEEE) 802.11 standards communication techniques. The descriptions of FIGS. 4-6 are not meant to imply physical or architectural limitations to the manner in which different embodiments may be implemented. Different embodiments of the present disclosure may be implemented in any suitably arranged communications system.

FIG. 4 illustrates an example wireless network 400 according to various embodiments of the present disclosure. The embodiment of the wireless network 400 shown in FIG. 4 is for illustration only. Other embodiments of the wireless network 400 could be used without departing from the scope of this disclosure.

The wireless network 400 includes APs 401 and 403. The APs 401 and 403 communicate with at least one network 430, such as the Internet, a proprietary Internet Protocol (IP) network, or other data network. The AP 401 provides wireless access to the network 430 for a plurality of STAs 411-414 within a coverage area 420 of the AP 401. The APs 401-403 may communicate with each other and with the STAs 411-414 using Wi-Fi or other WLAN communication techniques.

Depending on the network type, other well-known terms may be used instead of “access point” or “AP,” such as “router,” “gateway,” “WiFi hotspot,” “mobile AP,” or “mobile hotspot.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 401 and 403 and each of the STAs 411-414 may be a multi-link device (MLD). In such embodiments, APs 401 and 403 may be AP MLDs, and STAs 411-414 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 420 and 425, which are shown as approximately circular for the purposes of illustration and explanation only. It should be clearly understood that the coverage areas associated with APs, such as the coverage areas 420 and 425, may have other shapes, including irregular shapes, depending upon the configuration of the APs and variations in the radio environment associated with natural and man-made obstructions.

As described in more detail below, one or more of the APs may include circuitry and/or programming for facilitating mode selection operations for joint CDRX-TWT optimization for mobile hotspots. Although FIG. 4 illustrates one example of a wireless network 400, various changes may be made to FIG. 4. For example, the wireless network 400 could include any number of APs and any number of STAs in any suitable arrangement. Also, the AP 401 could communicate directly with any number of STAs and provide those STAs with wireless broadband access to the network 430. Similarly, each AP 401-403 could communicate directly with the network 430 and provide STAs with direct wireless broadband access to the network 430. Further, the APs 401 and/or 403 could provide access to other or additional external networks, such as external telephone networks or other types of data networks.

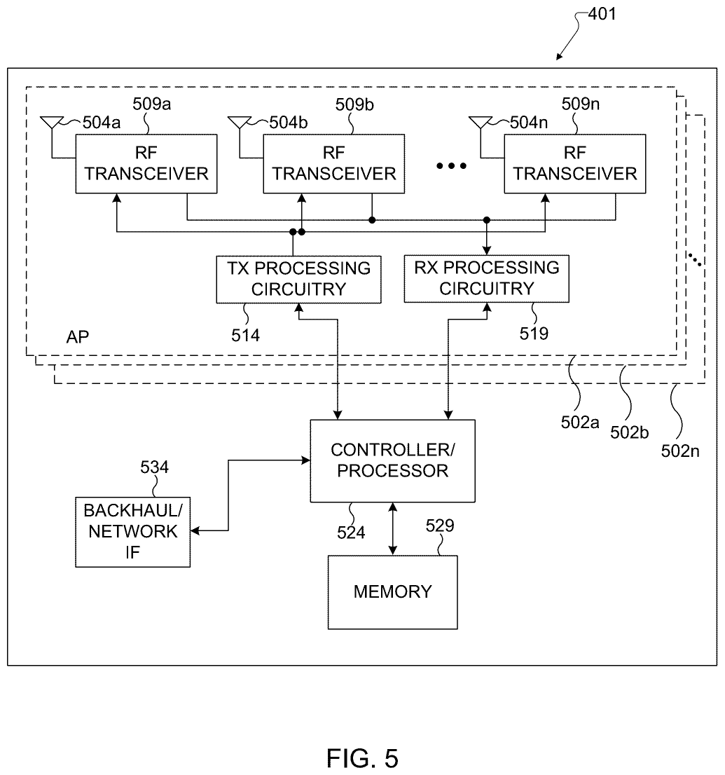

FIG. 5 illustrates an example AP 401 according to various embodiments of the present disclosure. The embodiment of the AP 501 illustrated in FIG. 5 is for illustration only, and the AP 403 of FIG. 4 could have the same or similar configuration. In the embodiments discussed herein below, the AP 401 is an AP MLD. However, APs come in a wide variety of configurations, and FIG. 5 does not limit the scope of this disclosure to any particular implementation of an AP.

The AP MLD 401 is affiliated with multiple APs 502a-502n (which may be referred to, for example, as AP1-APn). Each of the affiliated APs 502a-502n includes multiple antennas 504a-504n, multiple RF transceivers 509a-509n, transmit (TX) processing circuitry 514, and receive (RX) processing circuitry 519. The AP MLD 401 also includes a controller/processor 524, a memory 529, and a backhaul or network interface 534.

The illustrated components of each affiliated AP 502a-502n may represent a physical (PHY) layer and a lower media access control (LMAC) layer in the open systems interconnection (OSI) networking model. In such embodiments, the illustrated components of the AP MLD 401 represent a single upper MAC (UMAC) layer and other higher layers in the OSI model, which are shared by all of the affiliated APs 502a-502n.

For each affiliated AP 502a-502n, the RF transceivers 509a-509n receive, from the antennas 504a-504n, incoming RF signals, such as signals transmitted by STAs in the network 400. In some embodiments, each affiliated AP 502a-502n operates at a different bandwidth, e.g., 2.4 GHz, 5 GHz, or 6 GHz, and accordingly the incoming RF signals received by each affiliated AP may be at a different frequency of RF. The RF transceivers 509a-509n down-convert the incoming RF signals to generate IF or baseband signals. The IF or baseband signals are sent to the RX processing circuitry 519, which generates processed baseband signals by filtering, decoding, and/or digitizing the baseband or IF signals. The RX processing circuitry 519 transmits the processed baseband signals to the controller/processor 524 for further processing.

For each affiliated AP 502a-502n, the TX processing circuitry 514 receives analog or digital data (such as voice data, web data, e-mail, or interactive video game data) from the controller/processor 524. The TX processing circuitry 514 encodes, multiplexes, and/or digitizes the outgoing baseband data to generate processed baseband or IF signals. The RF transceivers 509a-509n receive the outgoing processed baseband or IF signals from the TX processing circuitry 514 and up-convert the baseband or IF signals to RF signals that are transmitted via the antennas 504a-504n. In embodiments wherein each affiliated AP 502a-502n operates at a different bandwidth, e.g., 2.4 GHz, 5 GHz, or 6 GHz, the outgoing RF signals transmitted by each affiliated AP may be at a different frequency of RF.

The controller/processor 524 can include one or more processors or other processing devices that control the overall operation of the AP MLD 401. For example, the controller/processor 524 could control the reception of forward channel signals and the transmission of reverse channel signals by the RF transceivers 509a-509n, the RX processing circuitry 519, and the TX processing circuitry 514 in accordance with well-known principles. The controller/processor 524 could support additional functions as well, such as more advanced wireless communication functions. For instance, the controller/processor 524 could support beam forming or directional routing operations in which outgoing signals from multiple antennas 504a-504n are weighted differently to effectively steer the outgoing signals in a desired direction. The controller/processor 524 could also support OFDMA operations in which outgoing signals are assigned to different subsets of subcarriers for different recipients (e.g., different STAs 411-414). Any of a wide variety of other functions could be supported in the AP MLD 401 by the controller/processor 524 including facilitating mode selection operations for MLDs in WLANs. In some embodiments, the controller/processor 524 includes at least one microprocessor or microcontroller. The controller/processor 524 is also capable of executing programs and other processes resident in the memory 529, such as an OS. The controller/processor 524 can move data into or out of the memory 529 as required by an executing process.

The controller/processor 524 is also coupled to the backhaul or network interface 534. The backhaul or network interface 534 allows the AP MLD 401 to communicate with other devices or systems over a backhaul connection or over a network. The interface 534 could support communications over any suitable wired or wireless connection(s). For example, the interface 534 could allow the AP MLD 401 to communicate over a wired or wireless local area network or over a wired or wireless connection to a larger network (such as the Internet). The interface 534 includes any suitable structure supporting communications over a wired or wireless connection, such as an Ethernet or RF transceiver. The memory 529 is coupled to the controller/processor 524. Part of the memory 529 could include a RAM, and another part of the memory 529 could include a Flash memory or other ROM.

As described in more detail below, the AP MLD 401 may include circuitry and/or programming for facilitating mode selection operations for MLDs in WLANs. Although FIG. 5 illustrates one example of AP MLD 401, various changes may be made to FIG. 5. For example, the AP MLD 401 could include any number of each component shown in FIG. 5. As a particular example, an AP MLD 401 could include a number of interfaces 534, and the controller/processor 524 could support routing functions to route data between different network addresses. As another particular example, while each affiliated AP 502a-502n is shown as including a single instance of TX processing circuitry 514 and a single instance of RX processing circuitry 519, the AP MLD 401 could include multiple instances of each (such as one per RF transceiver) in one or more of the affiliated APs 502a-502n. Alternatively, only one antenna and RF transceiver path may be included in one or more of the affiliated APs 502a-502n, such as in legacy APs. Also, various components in FIG. 5 could be combined, further subdivided, or omitted and additional components could be added according to particular needs.

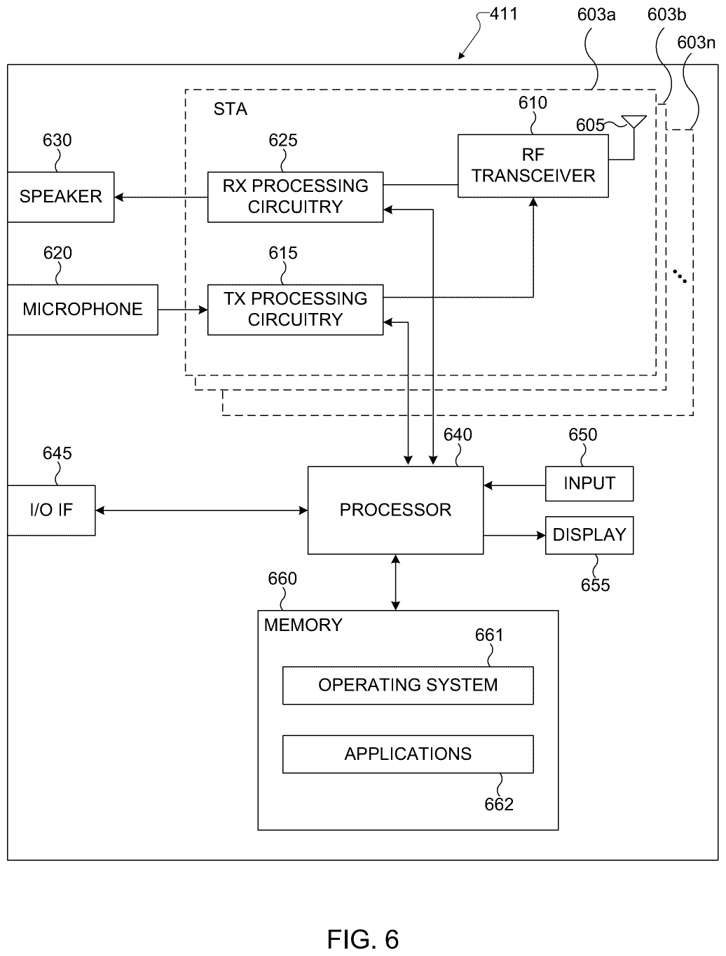

FIG. 6 illustrates an example STA 411 according to various embodiments of this disclosure. The embodiment of the STA 411 illustrated in FIG. 6 is for illustration only, and the STAs 411-415 of FIG. 4 could have the same or similar configuration. In the embodiments discussed herein below, the STA 411 is a non-AP MLD. However, STAs come in a wide variety of configurations, and FIG. 6 does not limit the scope of this disclosure to any particular implementation of a STA.

The non-AP MLD 1411 is affiliated with multiple STAs 603a-603n (which may be referred to, for example, as STA1-STAn). Each of the affiliated STAs 603a-603n includes antenna(s) 605, a radio frequency (RF) transceiver 610, TX processing circuitry 615, and receive (RX) processing circuitry 625. The non-AP MLD 411 also includes a microphone 620, a speaker 630, a controller/processor 640, an input/output (I/O) interface (IF) 645, a touchscreen 650, a display 655, and a memory 660. The memory 660 includes an operating system (OS) 661 and one or more applications 662.

The illustrated components of each affiliated STA 603a-603n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 603a-603n.

For each affiliated STA 603a-603n, the RF transceiver 610 receives from the antenna(s) 605, an incoming RF signal transmitted by an AP of the network 400. In some embodiments, each affiliated STA 603a-603n operates at a different bandwidth, e.g., 2.4 GHz, 5 GHz, or 6 GHz, and accordingly the incoming RF signals received by each affiliated STA may be at a different frequency of RF. The RF transceiver 610 down-converts the incoming RF signal to generate an intermediate frequency (IF) or baseband signal. The IF or baseband signal is sent to the RX processing circuitry 625, which generates a processed baseband signal by filtering, decoding, and/or digitizing the baseband or IF signal. The RX processing circuitry 625 transmits the processed baseband signal to the speaker 630 (such as for voice data) or to the controller/processor 640 for further processing (such as for web browsing data).

For each affiliated STA 603a-603n, the TX processing circuitry 615 receives analog or digital voice data from the microphone 620 or other outgoing baseband data (such as web data, e-mail, or interactive video game data) from the controller/processor 640. The TX processing circuitry 615 encodes, multiplexes, and/or digitizes the outgoing baseband data to generate a processed baseband or IF signal. The RF transceiver 610 receives the outgoing processed baseband or IF signal from the TX processing circuitry 615 and up-converts the baseband or IF signal to an RF signal that is transmitted via the antenna(s) 605. In embodiments wherein each affiliated STA 603a-603n operates at a different bandwidth, e.g., 2.4 GHz, 5 GHz, or 6 GHz, the outgoing RF signals transmitted by each affiliated STA may be at a different frequency of RF.

The controller/processor 640 can include one or more processors and execute the basic OS program 661 stored in the memory 660 in order to control the overall operation of the non-AP MLD 411. In one such operation, the main controller/processor 640 controls the reception of forward channel signals and the transmission of reverse channel signals by the RF transceiver 610, the RX processing circuitry 625, and the TX processing circuitry 615 in accordance with well-known principles. The main controller/processor 640 can also include processing circuitry configured to facilitate EMLMR operations for MLDs in WLANs. In some embodiments, the controller/processor 640 includes at least one microprocessor or microcontroller.

The controller/processor 640 is also capable of executing other processes and programs resident in the memory 660, such as operations for facilitating mode selection operations for MLDs in WLANs. The controller/processor 640 can move data into or out of the memory 660 as required by an executing process. In some embodiments, the controller/processor 640 is configured to execute a plurality of applications 662, such as applications for facilitating mode selection operations for MLDs in WLANs. The controller/processor 640 can operate the plurality of applications 662 based on the OS program 661 or in response to a signal received from an AP. The main controller/processor 640 is also coupled to the I/O interface 645, which provides non-AP MLD 411 with the ability to connect to other devices such as laptop computers and handheld computers. The I/O interface 645 is the communication path between these accessories and the main controller 640.

The controller/processor 640 is also coupled to the touchscreen 650 and the display 255. The operator of the non-AP MLD 411 can use the touchscreen 650 to enter data into the non-AP MLD 411. The display 655 may be a liquid crystal display, light emitting diode display, or other display capable of rendering text and/or at least limited graphics, such as from web sites. The memory 660 is coupled to the controller/processor 640. Part of the memory 660 could include a random-access memory (RAM), and another part of the memory 660 could include a Flash memory or other read-only memory (ROM).

Although FIG. 6 illustrates one example of non-AP MLD 411, various changes may be made to FIG. 6. For example, various components in FIG. 6 could be combined, further subdivided, or omitted and additional components could be added according to particular needs. In particular examples, one or more of the affiliated STAs 603a-603n may include any number of antenna(s) 605 for MIMO communication with an AP 401. In another example, the non-AP MLD 411 may not include voice communication or the controller/processor 640 could be divided into multiple processors, such as one or more central processing units (CPUs) and one or more graphics processing units (GPUs). Also, while FIG. 6 illustrates the non-AP MLD 411 configured as a mobile telephone or smartphone, non-AP MLDs can be configured to operate as other types of mobile or stationary devices.

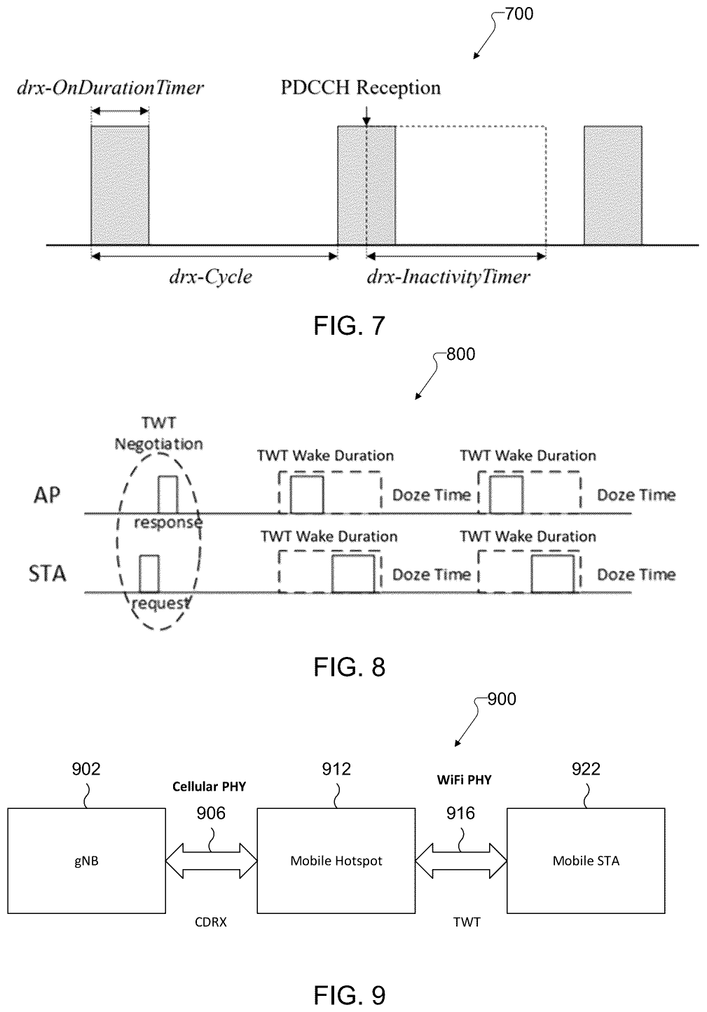

Cellular communication systems use continuous mode discontinuous reception (CDRX), which enables the radio resource control (RRC)-connected UE to wake up periodically at predetermined intervals to monitor the physical downlink control channel (PDCCH). If there is no PDCCH, the UE enters a power saving sleep state. The CDRX is configured by the network (NW) using RRC-configuration through three main parameters. These parameters are drx-Cycle drx-onDurationTimer, and drx-InactivityTimer, and are illustrated in FIG. 7.

FIG. 7 illustrates an example of CDRX operation 700 according to various embodiments of this disclosure. The embodiment of CDRX operation in FIG. 7 is for illustration only. Other embodiments of CDRX operation could be used without departing from the scope of this disclosure.

As illustrated in FIG. 7, the drx-Cycle parameter defines a periodicity with which the UE wakes up. Once the UE wakes up, the UE monitors PDCCH during a time defined by the drx-onDurationTimer parameter. If a PDCCH is not detected during the time defined by drx-onDurationTimer, the UE goes back to sleep. Otherwise, the UE extends the DRX active time by a time defined by the drx-InactivityTimer parameter. The time defined by the drx-InactivityTimer parameter allows the UE active duration to be extended depending on the traffic. Thus, the actual duty cycle of the device varies depending on the traffic. For instance, even with CDRX configured the device may not go to sleep, as the drx-InactivityTimer parameter may continually update to extend the UE active duration as traffic is received.

Although FIG. 7 illustrates one example of CDRX operation 700, various changes may be made to FIG. 7. For example, the length of drx-Cycle, drx-onDurationTimer, and drx-InactivityTimer may vary, etc. according to particular needs.

The WiFi, IEEE 802.11ax amendment introduced features for improving peak throughput and efficiency in an environment crowded by many 802.11 devices such as airports, stadiums, and the like. Target Wake Time (TWT) is one of the important features of the IEEE 802.11ax amendment and is illustrated in FIG. 8.

FIG. 8 illustrates an example of IEEE 802.11ax TWT operation 800 according to various embodiments of this disclosure. The embodiment of TWT operation in FIG. 8 is for illustration only. Other embodiments of TWT operation could be used without departing from the scope of this disclosure.

As illustrated in FIG. 8, the TWT feature of IEEE 802.11ax enables wake time negotiation between an Access point (AP) and its station (STA) for improving power efficiency. As FIG. 8 illustrates, a STA sends a TWT negotiation request and receives a TWT negotiation response from an AP to establish various TWT parameters. The negotiated parameters include the TWT wake duration (also called service period), the TWT wake interval (TWT wake time+doze time), and initial wake time (offset). The TWT parameters highly affect latency and throughput as well as power efficiency, which are directly related to quality of service (QoS) and customer experience. Services with different traffic characteristics will have different TWT parameter configurations for better QoS.

Although FIG. 8 illustrates one example of example of IEEE 802.11ax TWT operation 800, various changes may be made to FIG. 8. For example, the length of the TWT wake duration, TWT wake interval, and initial wake time may vary, etc. according to particular needs.

FIG. 9 illustrates an example mobile hotspot scenario 900 according to various embodiments of this disclosure. The embodiment of a mobile hotspot in FIG. 9 is for illustration only. Other embodiments of a mobile hotspot could be used without departing from the scope of this disclosure.

The example of FIG. 9 depicts an overall block diagram of a mobile hotspot 912 with cellular connection 906 to a gNB 902. The cellular connection 906 employs CDRX. Mobile hotspot 912 also has a WiFi connection 916 with a mobile STA 922. Wi-Fi connection 916 employs TWT. In the example of FIG. 9, mobile hotspot 912 is a UE with regard to cellular connection 906, and is an AP with regard to WiFi connection 916. Mobile STA 922 is representative of any Wi-Fi enabled device (e.g., laptop, UE, tablet, etc.) that seeks Wi-Fi connectivity with the mobile hotspot 912. The connected mode discontinuous reception (CDRX) allows the mobile hotspot to go to sleep when there is no data at the eNB/gNB for the UE. Note that the mobile hotspot 912 can always come out of sleep if it has some data to send to the eNB/gNB. CDRX can also be optionally configured with a short cycle, in addition to the drx-Cycle, but for simplicity the present disclosure limits discussion to the aforementioned three parameters. This is because the optimization of the short cycle—if configured—will follow an approach similar to the optimization of drx-Cycle, and hence the proposed embodiments can be easily generalized. The power consumption of a WiFi module in the Mobile STA 922 is controlled via target wake time (TWT). Through TWT, the mobile STA 922 can save power by waking up and dozing periodically. The two parameters that control the TWT behavior are the TWT wake interval T, and the TWT target wake duration Td (also called service period).

Although FIG. 9 illustrates an example of mobile hotspot scenario 900, various changes may be made to FIG. 9. For example, the number of STAs may change, the connection types may vary, etc. according to particular needs. It should be understood that while FIG. 9 illustrates a mobile hotspot 912, mobile hotspot 912 may also be referred to as a mobile AP.

Connected mode discontinuous reception (CDRX) is a feature of LTE/5G devices that allows devices to discontinue PDCCH monitoring and enter a sleep state to conserve energy if there is no DL data for the UE. Similarly, target wake time (TWT) is a solution for WiFi devices to periodically doze and wake up for energy conservation. When a device is used as a mobile hotspot, the device is using both WiFi and Cellular functionality at the same time. The parameters that control the CDRX behavior and the TWT behavior, however, are not jointly optimized for the mobile hotspot use case. Joint optimization specifically for the hotspot use case can ensure that the CDRX and TWT parameters are properly chosen to meet QoS requirement at the STA, while saving power at the STA and/or the mobile hotspot.

Since a mobile hotspot is aware of the traffic consumption over the mobile hotspot, the mobile hotspot can decide the CDRX parameters and the TWT parameters that help save power at the STA/AP while meeting the QoS requirement of any currently active applications at the STA/AP.

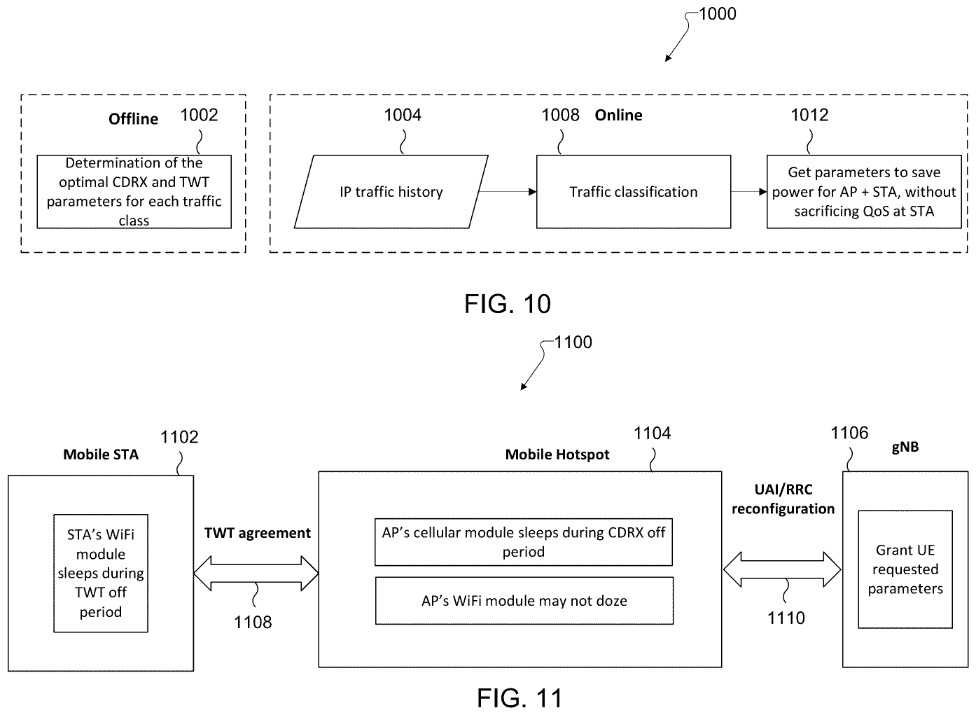

Both CDRX and TWT control the time domain sleep and wake up behavior of the devices. Depending on the traffic type, these parameters can be optimized to save power for the mobile hotspot and the STA, as illustrated in FIG. 10, without sacrificing the QoS for the STA.

FIG. 10 illustrates a procedure 1000 for joint optimization of CDRX and TWT parameters according to embodiments of the present disclosure. An embodiment of the method illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments of joint optimization of CDRX and TWT parameters could be used without departing from the scope of this disclosure.

As illustrated in FIG. 10, the procedure 1000 begins at step 1008. At step 1008, a traffic classifier takes the IP traffic history 104 as input, and classifies the current traffic into one or multiple of traffic classes. Depending on the prediction of the traffic classifier, at step 1012 some parameters are obtained that can allow an AP and a STA to save power. The parameters may be chosen based on a previously performed offline operation 1002, where optimal CDRX and TWT parameters were obtained for each of a plurality of traffic classes.

Although FIG. 10 illustrates one example of a procedure 1000 for joint optimization of CDRX and TWT parameters, various changes may be made to FIG. 10. For example, while shown as a series of steps, various steps in FIG. 10 could overlap, occur in parallel, occur in a different order, or occur any number of times.

Various embodiments disclosed herein describe variations of the implementation of a traffic classifier (either at an AP, a STA, or both), and various ways the parameters may be optimized to maintain QoS while saving power.

In one embodiment, TWT negotiation and CDRX parameter sharing with a gNB is performed simultaneously. Such an embodiment may be preferable in scenarios where there is a high probably that the gNB grants the UE preferred CDRX parameters.

In one embodiment, first the UE shares preferred CDRX parameters with the gNB. If the gNB grants the UE's preferred CDRX parameters, then the TWT negotiation based on the determined traffic class is performed. Otherwise, a default TWT negotiation behavior is resumed. The default behavior may be either no TWT negotiation (e.g., no power saving) or the default behavior may be TWT negotiation based on some default parameters that can ensure the QoS of all applications but may not lead to considerable power savings (e.g., a TWT wake duration only slightly shorter than the TWT wake interval). Such an embodiment may be preferable in scenarios where there is a high probability that the gNB doesn't grant the UE's preferred CDRX parameters.

In one embodiment, channel condition is also taken into consideration for CDRX and TWT parameter determination. For example, if the condition of the cellular channel is poor, the CDRX functionality may not be used or may be used with CDRX parameters suitable to meet QoS for a wide variety of applications, but the CDRX parameters (e.g., a long inactivity timer and short cycle) may not result in considerable power saving. Similarly, if the condition of the WiFi channel is poor or subject to a high amount of contention, the TWT feature may not be used, or may be renegotiated to deal with the poor channel or high contention scenarios. For example, the negotiated parameters (e.g., a TWT wake duration only slightly shorter that the TWT wake interval) may ensure the QoS of all applications but may not result in considerable power savings.

The embodiments of the present disclosure are presented assuming a cellular—WiFi hotspot, in which one link is cellular and one link is WiFi. Specifically, the data is provided by a cellular link to a device connected via WiFi to a hotspot. The CDRX for the cellular link and TWT for the WiFi link are optimized. However, the embodiments described here in are also applicable to a WiFi—WiFi hotspot, in which the TWT parameters of both WiFi links are optimized.

FIG. 11 illustrates an example 1100 of conventional behavior of an AP in a mobile hotspot scenario according to embodiments of the present disclosure. An embodiment of the process illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments of an AP in a mobile hotspot scenario could be used without departing from the scope of this disclosure.

In the example of FIG. 11, a mobile hotspot 1104 is a UE with respect to a gNB 1106, and is serving as an AP for mobile STA 1102. According to conventional AP behavior, if a TWT agreement 1108 is in place between mobile hotspot 1104 and mobile STA 1102, only mobile STA 1102 may save power by dozing based on the TWT agreement 108. Mobile hotspot 1104 may only save power by periodically turning off its cellular module through the CDRX operation. The parameters for CDRX operation are shared with gNB 1106 based on the UE assistance information (UAI) framework proposed in Release 16 of the 3GPP, illustrated in FIG. 11 as UAI/RRC reconfiguration 1110. Note that in 5G NR the UAI framework is also used for the UE to indicate its preference on BW and MIMO layers. The present disclosure focuses on CDRX because TWT in WiFi provides a clear analog to CDRX in 5G NR. Therefore, in conventional schemes such as illustrated in FIG. 11, an AP does not save any power due to the TWT operation. An AP may not doze in the conventional TWT framework for two particular reasons. First, a STA that is in TWT doze can still wake up and send signals to the AP. Second, an AP is often serving multiple STAs that are typically interleaved in the time domain. Interleaving the STAs in the time domain reduces the contention between STAs when communicating with the AP.

Although FIG. 11 illustrates one example 1100 of conventional behavior of an AP in a mobile hotspot scenario, various changes may be made to FIG. 11. For example, while shown as a series of steps, various steps in FIG. 11 could overlap, occur in parallel, occur in a different order, or occur any number of times. It should be understood that while FIG. 11 illustrates a mobile hotspot 1104, mobile hotspot 1104 may also be referred to as a mobile AP.

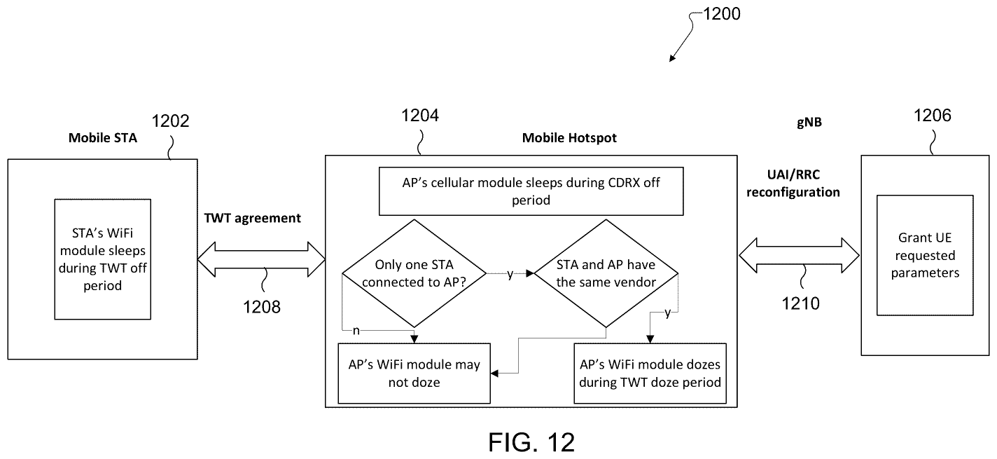

The typical application of a mobile hotspot is to provide WiFi to a device that may not have cellular access. As such, it can be fairly assumed that a mobile hotspot AP serves a much smaller number of STAs than a typical AP, which may be installed specifically to provide WiFi access. Exploiting this observation, a proprietary solution is presented herein for mobile hotspots. Specifically, if the mobile hotspot is connected to only a single device, and the AP and STA both are from the same vendor, there can be a common understanding between the AP and STA that during TWT doze time, the AP of the mobile hotspot will not be awake. This is illustrated in FIG. 12 below.

FIG. 12 illustrates an example 1200 of dozing behavior of an AP in a mobile hotspot scenario according to embodiments of the present disclosure. An embodiment of the process illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments of dozing behavior of an AP in a mobile hotspot scenario could be used without departing from the scope of this disclosure.

In the example of FIG. 12, a mobile hotspot 1204 is a UE with respect to a gNB 1206, and is serving as an AP for mobile STA 1202. According to an embodiment of mobile hotspot AP dozing behavior, if a TWT agreement 1108 is in place between mobile hotspot 1104 and mobile STA 1102, mobile STA 1102 and mobile hotspot 1204 may save power by dozing based on the TWT agreement 1208. Mobile hotspot 1204 may additionally save power by periodically turning off its cellular module through the CDRX operation. The parameters for CDRX operation are shared with gNB 1206 based on the UE assistance information (UAI) framework proposed in Release 16 of the 3GPP, illustrated in FIG. 11 as UAI/RRC reconfiguration 1210.

According to the example of FIG. 12, mobile hotspot 1204 may perform dozing only when only one STA is connected to mobile hotspot 1204, and when the connected STA (i.e., STA 1202) and mobile hotspot 1204 share vendors. The same vendor requirement exists in this example because AP dozing is not supported by the latest the IEEE 802.11 standards documents. As such, the devices need to support a proprietary process to perform TWT agreement 1208. However, such a proprietary process may be implemented by any vendor's products. In one embodiment, mobile hotspot 1204 and STA 1202 may be from a pool of vendors that permit the mobile hotspot to doze. In this embodiment, if the STA and mobile hotspot are from the pool of vendors, then the mobile hotspot is permitted to doze during TWT doze time.

The condition of only connecting to a single STA can also be relaxed. In one embodiment, if mobile hotspot 1204 is connected to a small number of STAs that is below a threshold (e.g., 2-3), such that remaining ON to serve all of the STAs, and then dozing when it is TWT doze time for all the connected STAs is worthwhile from a power saving and complexity of implementation perspective, then the mobile hotspot will doze.

In one embodiment, the expectation that the mobile hotspot dozes when it is TWT doze time for the STA is by default. That is to say, as soon as is it determined that the STA and AP are from the same supported vendor or pool of vendors, both devices should expect that the mobile hotspot dozes during TWT doze time for the STA. In another embodiment, specific signaling between the STA and the mobile hotspot is used to indicate that the mobile hotspot will doze during the STA doze time. For example, there is a vendor specific information element in the IEEE 802.11 standard that can be used by the vendors to communicate such information. The vendor specific information element in the IEEE 802.11 beacon frame is 253 bytes, and does not have any specific format.

Although FIG. 12 illustrates one example 1200 of dozing behavior of an AP in a mobile hotspot scenario, various changes may be made to FIG. 12. For example, while shown as a series of steps, various steps in FIG. 12 could overlap, occur in parallel, occur in a different order, or occur any number of times. It should be understood that while FIG. 12 illustrates a mobile hotspot 1204, mobile hotspot 1204 may also be referred to as a mobile AP.

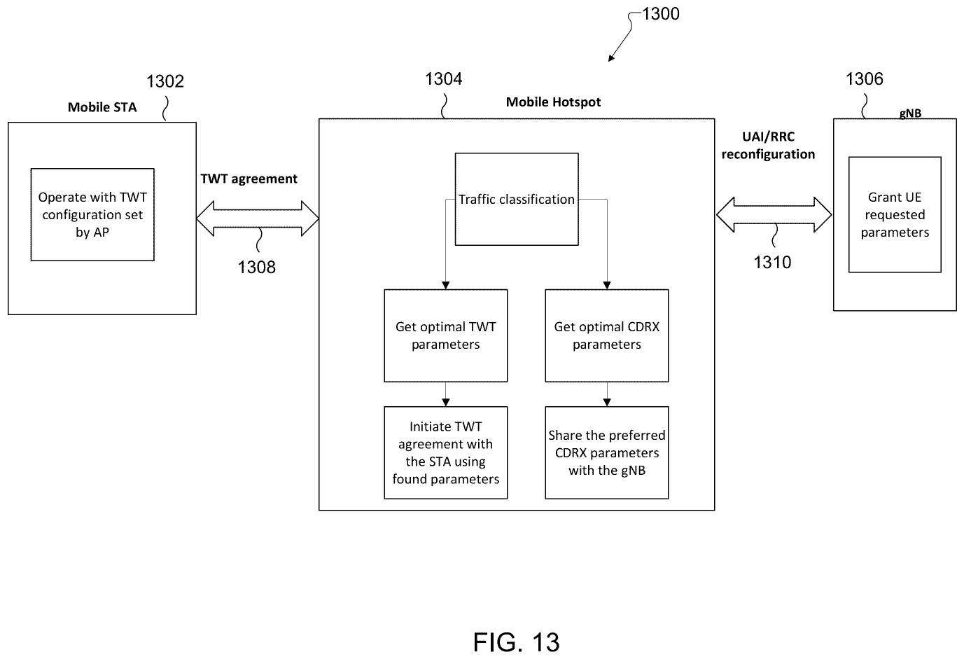

When implementing mobile hotspot dozing as described herein, traffic classification may be utilized to determine optimal TWT and CDRX parameters for the mobile hotspot. The traffic classification may be performed by a traffic classifier implemented within the mobile hotspot similar as illustrated in in FIG. 13.

FIG. 13 illustrates an example process 1300 for determining TWT and CDRX parameters based on traffic classification. An embodiment of the process illustrated in FIG. 13 is for illustration only. One or more of the components illustrated in FIG. 13 may be implemented in specialized circuitry configured to perform the noted functions or one or more of the components may be implemented by one or more processors executing instructions to perform the noted functions. Other embodiments of determining TWT and CDRX parameters based on traffic classification could be used without departing from the scope of this disclosure.

In the example of FIG. 13, a mobile hotspot 1304 is a UE with respect to a gNB 1306, and is serving as an AP for mobile STA 1302. According to an embodiment of mobile hotspot AP dozing behavior, if a TWT agreement 1308 is in place between mobile hotspot 1304 and mobile STA 1302, mobile STA 1302 and mobile hotspot 1304 may save power by dozing based on the TWT agreement 1308 similar as described regarding FIG. 12. Mobile hotspot 1304 may additionally save power by periodically turning off its cellular module through the CDRX operation. The parameters for CDRX operation are shared with gNB 1306 based on the UE assistance information (UAI) framework proposed in Release 16 of the 3GPP, illustrated in FIG. 13 as UAI/RRC reconfiguration 1310.

In the example of FIG. 13, mobile hotspot 1304 comprises a traffic classifier. the traffic classifier may consider both IP packet history and PHY layer metrics to determine the application(s) that are running on the hotspot 1304. According to one embodiment of the traffic classifier, different applications can be broadly categorized into real time and non-real time traffic, e.g.,
Non-real time (non-RT) traffic: Streaming (e.g., YouTube, Netflix, Prime video, etc.), browsing (e.g., browsing in an app or on web browser).
Real time (RT) traffic: Audio call (e.g., WhatsApp, Messenger, Viber, etc.), video call (e.g., WhatsApp, Messenger, MS Teams, etc.), Online low-bit rate gaming (e.g., Among Us), Online high-bit rate gaming (e.g., PUBG, Call of duty, etc.).

The application classes can also be subclassified to have more than two classes. For example, in one embodiment the traffic may be classified according to four classes: (i) real time low throughout, (ii) real time high throughput, (iii) non-real time low throughput, and (iv) non-real time high throughput. In one embodiment, the traffic classifier takes IP packet history over a specified time window as input and predicts the applications that may be running at the UE. The traffic classifier may consider features such as packet inter-arrival time, packet size, flow type, number of active flows, traffic class of each flow, etc., to determine the application. Further, the 3GPP specified 5QI values associated with the packet data unit (PDU) session may also indicate the traffic class. The traffic classifier may output the predicted traffic class, or the probabilities of each class. The traffic classifier may be built using machine learning (ML) algorithms like XGBoost or convolutional neural networks (CNN) etc. The traffic classifier can be built based on all the IP traffic, i.e., all packets, or based on the flows, i.e., separate classification for each five-tuple (source IP address/port number, destination IP address/port number and the protocol in use, i.e., transmission control protocol (TCP)/user datagram protocol (UDP) etc.). The additional information along with inference from IP packet history may result in more accurate detection of the service type. In one embodiment, the traffic classifier is capable of distinguishing between the traffic consumed at the hotspot locally, and the traffic with STA as the end destination. Since the hotspot needs to only forward the traffic consumed at the STA, the hotspot by design is capable of distinguishing between the traffic meant for STA and for local consumption. This can be done e.g., by looking at the destination IP addresses of the packets. As such the AP/STA is in a position to decide the TWT parameters specifically for the STA based on the STA traffic, and can decide the CDRX parameters based on the overall power consumption. As an example, assume that the STA is browsing internet—which does not have a stringent latency requirement, whereas the hotspot or AP is performing an audio call—which has a stringent latency requirement. Based on the traffic classification the TWT parameters for the STA will be the parameters of the browsing, i.e., a non-real time application type, whereas the CDRX parameters will be based on audio call, i.e., a real time application, which will have stringent latency requirement. For example, TWT agreement 1308 may be negotiated based on the browsing traffic classification, and UAI/RRC reconfiguration 1310 may be performed based on the audio call traffic classification. The procedure to obtain the TWT and CDRX parameters once the traffic type has been classified can be simply based on a look up table that stores the TWT and CDRX parameters corresponding to each traffic class. Such look up tables can be generated by simulating/experimenting different traffic types and checking for the most power saving TWT and CDRX parameters that can still meet QoS, e.g., latency requirement. The implementation of the traffic classifier at the mobile hotspot allows extra power savings for the STA, since the STA does not need to run the traffic classifier locally.

Although FIG. 13 illustrates one example process 1300 for determining TWT and CDRX parameters based on traffic classification, various changes may be made to FIG. 13. For example, while shown as a series of steps, various steps in FIG. 13 could overlap, occur in parallel, occur in a different order, or occur any number of times. It should be understood that while FIG. 13 illustrates a mobile hotspot 1304, mobile hotspot 1304 may also be referred to as a mobile AP.

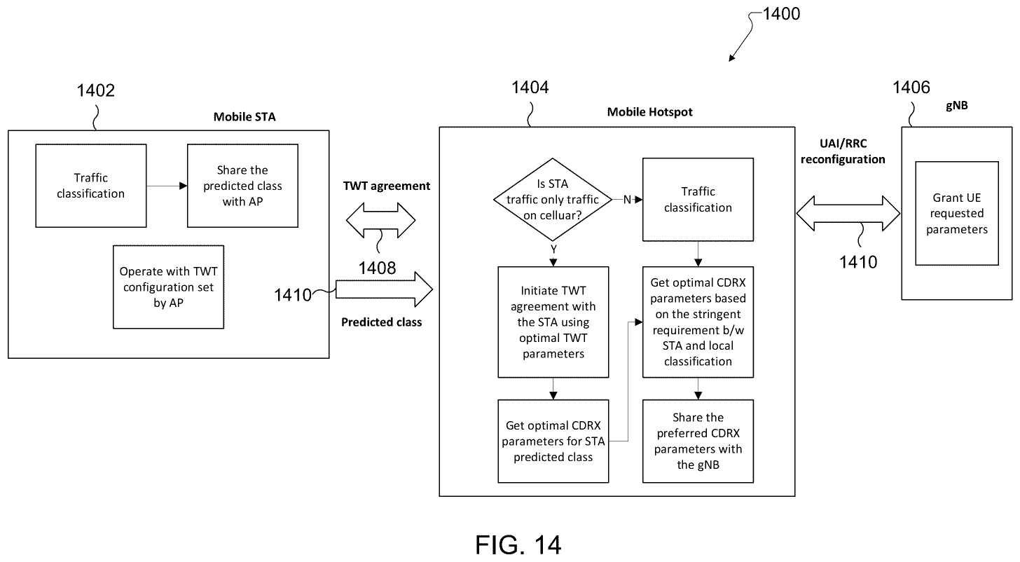

In another embodiment, a traffic classifier for the STA traffic runs on the STA as illustrated in FIG. 14.

FIG. 14 illustrates an example process 1400 for determining TWT and CDRX parameters based on traffic classification. An embodiment of the process illustrated in FIG. 14 is for illustration only. One or more of the components illustrated in FIG. 14 may be implemented in specialized circuitry configured to perform the noted functions or one or more of the components may be implemented by one or more processors executing instructions to perform the noted functions. Other embodiments of determining TWT and CDRX parameters based on traffic classification could be used without departing from the scope of this disclosure.

In the example of FIG. 14, a mobile hotspot 1404 is a UE with respect to a gNB 1406, and is serving as an AP for mobile STA 1402. According to an embodiment of mobile hotspot AP dozing behavior, if a TWT agreement 1408 is in place between mobile hotspot 1404 and mobile STA 1402, mobile STA 1402 and mobile hotspot 1404 may save power by dozing based on the TWT agreement 1408 similar as described regarding FIG. 12. Mobile hotspot 1404 may additionally save power by periodically turning off its cellular module through the CDRX operation. The parameters for CDRX operation are shared with gNB 1406 based on the UE assistance information (UAI) framework proposed in Release 16 of the 3GPP, illustrated in FIG. 14 as UAI/RRC reconfiguration 1410.

In the example of FIG. 14, mobile hotspot 1404 determines if the traffic associated with STA 1402 is the only traffic it is consuming on the cellular link. For example, mobile hotpot 14 may determine whether the destination IP addresses of the packets at mobile hotspot 1404, are intended for mobile hotspot 1404 or mobile STA 1402. If the packets are intended for STA 1402, mobile hotspot 1404 does not need to perform traffic classification Instead it receives a predicted traffic class 1410 from STA 1402. The predicted traffic class 1410 can be shared using the vendor specific information element field of the IEEE 802.11 beacon frame. Mobile hotspot 1404 uses the STA 1402 predicted class to determine the optimal TWT and CDRX parameters. If, however, there is also traffic destined for mobile hotspot 1404, then the mobile hotspot 1404 performs traffic classification locally. Subsequently, based on the received predicted class 1410 from STA 1402 and traffic classification of its own, mobile hotspot 1404 determines what CDRX parameters to use. The CDRX parameters should be based on the more stringent requirement among the local traffic classification and the STA classification. The benefit of this embodiment is that mobile station 1404 can save complexity by not running a local traffic classifier. The disadvantage is that there is additional communication overhead between STA 1402 and mobile hotspot 1404. Given there is n number of classes, up to n bits of information are required—assuming multiclass classification. An example value of n is 4, and example classes are: (i) real time low throughout, (ii) real time high throughput, (iii) non-real time low throughput, and (iv) non-real time high throughput. This communication should occur at the rate at which the STA updates its prediction of the traffic class, e.g., 0.5 seconds.

Although FIG. 14 illustrates one example process 1400 for determining TWT and CDRX parameters based on traffic classification, various changes may be made to FIG. 14. For example, while shown as a series of steps, various steps in FIG. 14 could overlap, occur in parallel, occur in a different order, or occur any number of times. It should be understood that while FIG. 14 illustrates a mobile hotspot 1404, mobile hotspot 1404 may also be referred to as a mobile AP.

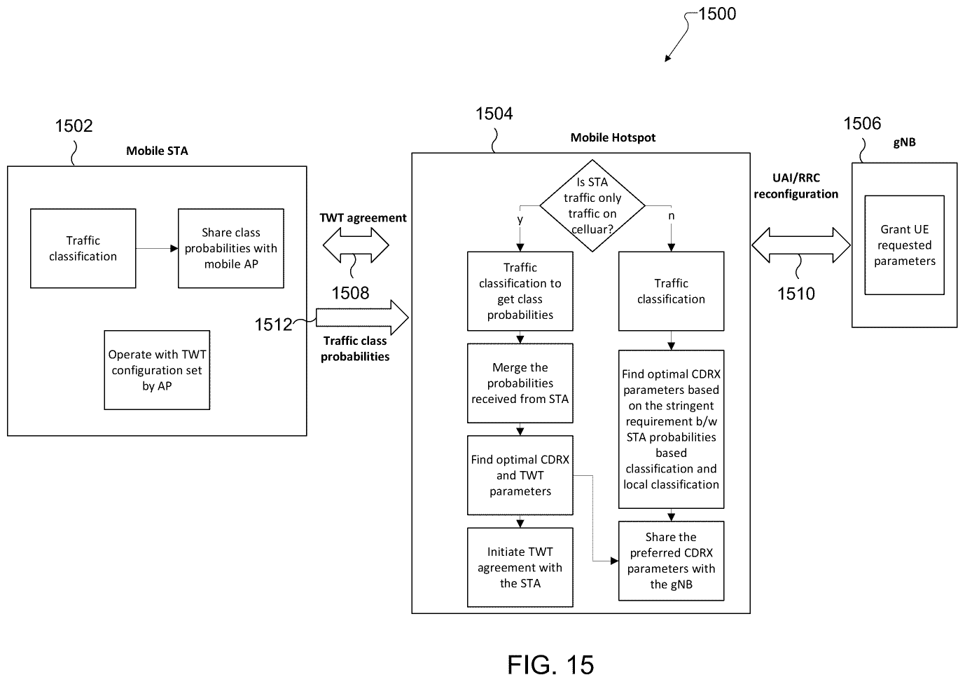

In another implementation, a traffic classifier for the STA traffic runs at both the STA and AP as illustrated in FIG. 15.

FIG. 15 illustrates an example process 1500 for determining TWT and CDRX parameters based on traffic classification. An embodiment of the process illustrated in FIG. 15 is for illustration only. One or more of the components illustrated in FIG. 15 may be implemented in specialized circuitry configured to perform the noted functions or one or more of the components may be implemented by one or more processors executing instructions to perform the noted functions. Other embodiments of determining TWT and CDRX parameters based on traffic classification could be used without departing from the scope of this disclosure.

In the example of FIG. 15, a mobile hotspot 1504 is a UE with respect to a gNB 1506, and is serving as an AP for mobile STA 1502. According to an embodiment of mobile hotspot AP dozing behavior, if a TWT agreement 1508 is in place between mobile hotspot 1504 and mobile STA 1502, mobile STA 1502 and mobile hotspot 1504 may save power by dozing based on the TWT agreement 1508 similar as described regarding FIG. 12. Mobile hotspot 1504 may additionally save power by periodically turning off its cellular module through the CDRX operation. The parameters for CDRX operation are shared with gNB 1506 based on the UE assistance information (UAI) framework proposed in Release 16 of the 3GPP, illustrated in FIG. 15 as UAI/RRC reconfiguration 1510.

In the example of FIG. 15, STA 1502 runs a traffic classifier and shares the probabilities of different traffic classes 1512 with the mobile hotspot 1504. For instance, a vendor specific information element can be used by STA 1502 to communicate such information. The vendor specific information element in 802.11 beacon frame is 253 bytes, and does not have any specific format. If the STA traffic is the only traffic on mobile hotspot 1502's cellular link, then mobile hotspot 1502 AP performs a traffic classification locally, receives the traffic class probabilities 1512 from STA 1502, and performs a soft merging of the traffic class probabilities 1504 with results of the local traffic classification to obtain a final traffic class prediction (i.e., a merged traffic class prediction). As an example, if the predicted probability of class n by the STA 1502 is p_{STA}_{ₙ}, and the predicted probability of class n by mobile hotspot 1504 is p_{AP}_{ₙ}, then the merged probability of class n is pₙ=(p_{STA}_{ₙ}+p_{AP}_{ₙ})/2. Then the class n with the highest probability pₙ is the final traffic class prediction. Based on the prediction, the optimal CDRX and the TWT parameters are determined by mobile hotspot 1504. If there is local traffic consumption at mobile hotspot 1504, then mobile hotspot 1504 uses the traffic class probabilities 1512 shared by STA 1502 to determine the TWT parameters and uses local traffic to determine the CDRX parameters. The benefits of this approach are twofold. First, due to TWT behavior, the traffic pattern observed at mobile hotspot 1504 might be slightly different from the traffic pattern observed at STA 1502. The soft combining allows a better prediction of the classes, by taking STA 1502 and mobile hotspot 1504 predictions into account. Second, the traffic classifier at mobile hotspot 1504 and STA 1502 may not be identical, e.g., due to different implementations. Hence taking the view of both devices can overcome the limitations in the traffic classifier of one device. The disadvantage of this approach is a high overhead since floating point probabilities are shared between STA 1502 and mobile hotspot 1504.

In another embodiment, whether the traffic classifier is run at the STA 1502 is determined by power constraints. As an example, if STA 1502 is a laptop, it may be less power constrained than a smartphone and hence it may have more available resources to run the classifier at STA 1502. If STA 1502 is a smartphone then the classifier may run only at mobile hotspot 1504 to save STA 1502 power.

Although FIG. 15 illustrates one example process 1500 for determining TWT and CDRX parameters based on traffic classification, various changes may be made to FIG. 15. For example, while shown as a series of steps, various steps in FIG. 15 could overlap, occur in parallel, occur in a different order, or occur any number of times. It should be understood that while FIG. 15 illustrates a mobile hotspot 1504, mobile hotspot 1504 may also be referred to as a mobile AP.

Generally, the optimal TWT and CDRX parameters for each traffic class can be based on a look up table that stores the TWT and CDRX parameters corresponding to each traffic class. Such look up tables can be generated by simulating/experimenting different traffic types and checking for the most power saving TWT and CDRX parameters that can still meet some QoS, e.g., some latency requirements. The look up tables may be generated by searching over candidate values of the CDRX and the TWT. Example candidate values for the TWT and CDRX are given in Table 1. The candidate values are taken from the cellular and WiFi standards. In conventional solutions, the CDRX and TWT parameters are optimized separately, and values obtained from all the candidate values are listed in Table 1.

TABLE 1
Candidate values of the parameters
for CDRX and TWT optimization

| Parameter | Candidate values |
|---|---|
| CDRX Inactivity | 0 ms, 1 ms, 2 ms, 3 ms, 4 ms, 5 ms, 6 ms, |
| Timer | 8 ms, 10 ms, 20 ms, 30 ms, 40 ms, 50 ms, |
| | 60 ms, 80 ms, 100 ms, 200 ms, 300 ms, |
| | 500 ms, 750 ms, 1280 ms, 1920 ms, 2560 ms |
| CDRX Cycle | 10 ms, 20 ms, 32 ms, 40 ms, 60 ms, 64 ms, |
| | 70 ms, 80 ms, 128 ms, 160 ms, 256 ms, |
| | 320 ms, 512 ms, 640 ms, 1024 ms, 1280 ms, |
| | 2048 ms, 2560 ms, 5120 ms, 10240 ms |
| Target wake | Any integer multiple m of a base multiplier |
| duration T_{wd} | b = 256 μs |
| Target wake | Any integer multiple k of a base multiplier |
| interval Tᵢₙᵥ | b = 256 μs, where k ≥ m + 1 |

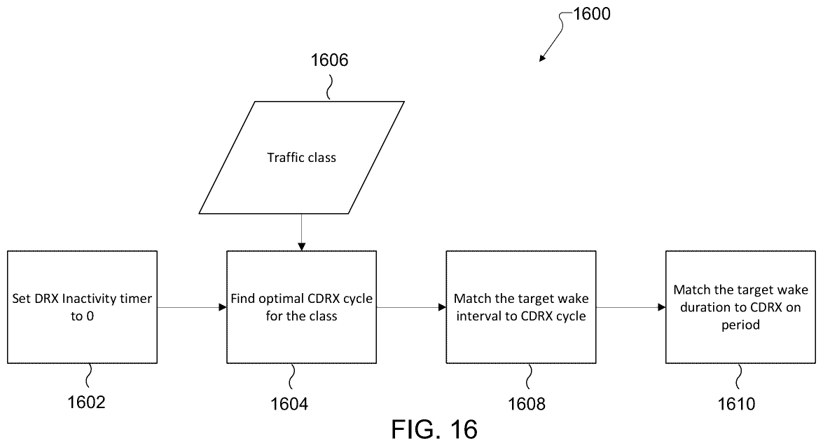

When the optimization is performed jointly for CDRX and TWT as in the hotspot scenario, the candidate set can be further limited. The CDRX inactivity timer allows the UE active duration to be extended depending on the traffic. This makes it difficult to predict the actual UE duty cycle. From the joint optimization perspective, the CDRX inactivity timer can always be set to 0, and CDRX search may be performed only over the CDRX cycle as illustrated in FIG. 16.

FIG. 16 illustrates an example process 1600 for joint optimization of TWT and CDRX parameters. An embodiment of the process illustrated in FIG. 16 is for illustration only. One or more of the components illustrated in FIG. 16 may be implemented in specialized circuitry configured to perform the noted functions or one or more of the components may be implemented by one or more processors executing instructions to perform the noted functions. Other embodiments of joint optimization of TWT and CDRX parameters could be used without departing from the scope of this disclosure.

In the example of FIG. 16, at step 1602, the CDRX inactivity timer is set to 0 and at step 1604 the optimal CDRX cycle is found based on a traffic class 1606. Traffic class 1606 may have been previously determined similar as described regarding FIGS. 13-15. Subsequently, at step 1608, the target wake duration is set to be equal to the CDRX ON duration. If the CDRX ON duration is represented as CDRX_{ON}, then the integer multiple m is found by solving argminₘ|CDRX_{ON}−m×b|. Subsequently, at step 1610, the target wake interval is matched to the CDRX long cycle. If the long cycle is represented as CDRXcycle, then the integer multiple k is found by solving argminₖ|CDRXcycle−k×b|, s. t., k≥m+1. Since the CDRX and TWT search space has been limited, the obtained parameters can be suboptimal for individual power consumption, i.e., power consumption due to CDRX, and power consumption due to TWT, but this joint optimization permits meaningful time synchronization between the TWT and the CDRX operation as later discussed herein.

Although FIG. 16 illustrates one example process 1600 for joint optimization of TWT and CDRX parameters, various changes may be made to FIG. 16. For example, while shown as a series of steps, various steps in FIG. 16 could overlap, occur in parallel, occur in a different order, or occur any number of times.

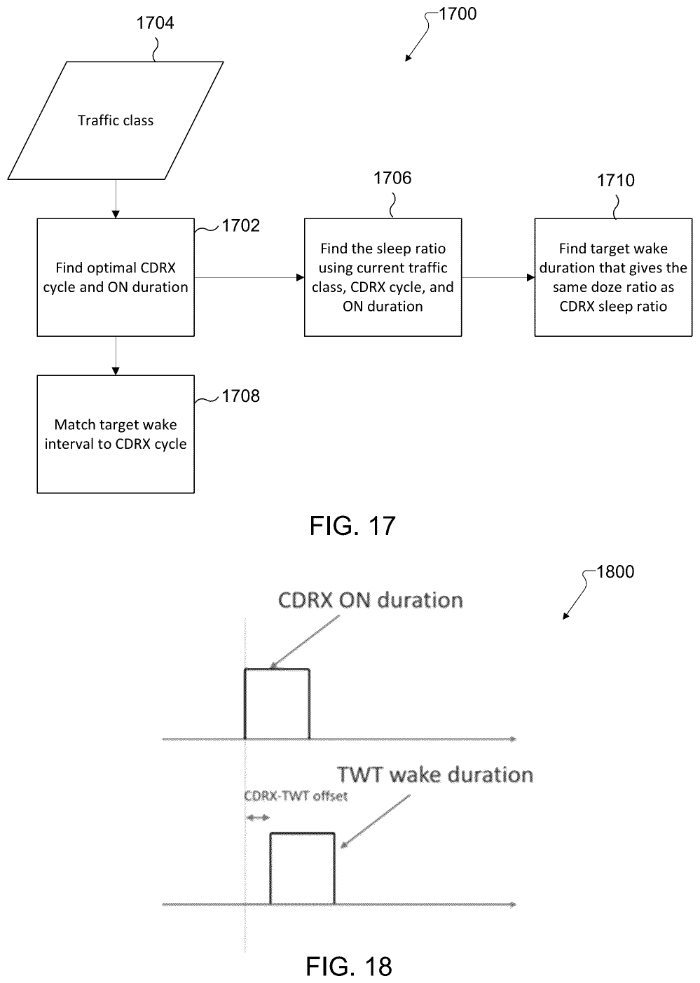

In another implementation, the CDRX inactivity timer is allowed to have non-zero values. The motivation of this embodiment compared to the embodiment discussed earlier is that the TWT itself can have early cycle termination. As such, once observed over longer period, the average duty cycle of the TWT (i.e., the doze ratio) may be less than what is expected from the wake time and the interval configuration. As such, empirical observations about the CDRX sleep ratio, i.e., the fraction of sleep time for the device, and the TWT actual observed duty cycle are used for joint optimization of the CDRX and the TWT parameters. The optimization method can be considered as a four step process as illustrated in FIG. 17.

FIG. 17 illustrates an example process 1700 for joint optimization of TWT and CDRX parameters. An embodiment of the process illustrated in FIG. 17 is for illustration only. One or more of the components illustrated in FIG. 17 may be implemented in specialized circuitry configured to perform the noted functions or one or more of the components may be implemented by one or more processors executing instructions to perform the noted functions. Other embodiments of joint optimization of TWT and CDRX parameters could be used without departing from the scope of this disclosure.

In the example of FIG. 17, at step 1702, optimal CDRX parameters are found based on traffic class 1704 (e.g., using the approach discussed regarding FIG. 16). Subsequently, at step 1706, the sleep ratio for the optimal parameters is empirically obtained, based on traffic class 1706. The sleep ratio can be determined by collecting the UE PHY logs and analyzing the time UE spends in CDRX sleep state while consuming traffic of each class. Subsequently, at step 1708, the target wake interval is set to match the CDRX cycle. At step 1710, with the wake interval set, actual TWT duty cycles are determined for a wide variety of target wake duration choices. Consider the following example:
1—First the optimal CDRX parameter found: CDRX cycle of 160 ms and CDRX inactivity timer of 40 ms, and CDRX on duration of 20 ms. If the inactivity timer never extends the CDRX, the duty cycle is 20/160×100=12.5%.
2—Then the CDRX sleep ratio is obtained empirically and the actual CDRX duty cycle is found to be 30%.
3—The target wake interval as close to CDRX cycle of 160 ms as possible is used. Since wake interval is integer multiple of 256 μs, k=625 is used to get target wake interval of 160 ms.
4—Now a wide variety of target wake durations are tested, i.e., values of m and the value of m is chosen that empirically gives the TWT duty cycle to be as close as 30%, i.e., our empirically determined CDRX duty cycle.
   Finally, the target wake duration that gives the TWT duty cycle to be as close to the CDRX actual duty cycle is chosen as the optimal parameter. The benefit of this implementation is that it permits non-zero CDRX inactivity timer, hence the search space for optimal parameters is larger, resulting in closer to optimal parameters.

In another embodiment, the channel conditions are also taken into consideration for optimization of the CDRX/TWT parameters.

When there is only a single STA connected with the mobile AP, it is beneficial to align the CDRX duration (i.e., the ON duration of the CDRX) and the TWT duration (i.e., the TWT target wake duration) as shown in FIG. 18.

FIG. 18 illustrates an example 1800 of CDRX on duration and TWT target wake duration alignment according to embodiments of this disclosure. The embodiment of alignment illustrated in FIG. 18 is for illustration only., and the STAs 411-415 of FIG. 4 could have the same or similar configuration. Different embodiments of CDRX ON duration and TWT target wake duration alignment could be used without departing from the scope of this disclosure.

In the example of FIG. 18, a CDRX on duration is aligned with a TWT wake duration, with a CDRX-TWT offset between the alignment.

Although FIG. 18 illustrates an example 1800 of CDRX on duration and TWT target wake duration alignment, various changes may be made to FIG. 18. For example, various changes to the alignment, the durations, the CDRX-TWT offset, etc. according to particular needs.

A tight alignment between CXRX ON duration and TWT wake duration is particularly beneficial for real time applications where an incoming packet at the mobile hotspot is sent to the STA as soon as possible without any additional delay caused by misalignment of the TWT and the CDRX ON durations. As an example, tight alignment could mean that the beginning of the CDRX ON duration and TWT wake duration has an offset of no more than 10% of the minimum between CDRX ON duration and TWT wake duration. There, however, may be some small CDRX-TWT offset to capture the processing and transmission delay from the mobile hotspot. This offset can be on the order of a few ms, and the tight alignment is assumed by taking this offset into consideration, i.e., alignment means CDRX ON duration and TWT wake duration are aligned up to CDRX-TWT offset. Furthermore, simultaneously active cellular and WiFi does not cause any interference, since these two communication mechanisms typically operate on different frequencies.

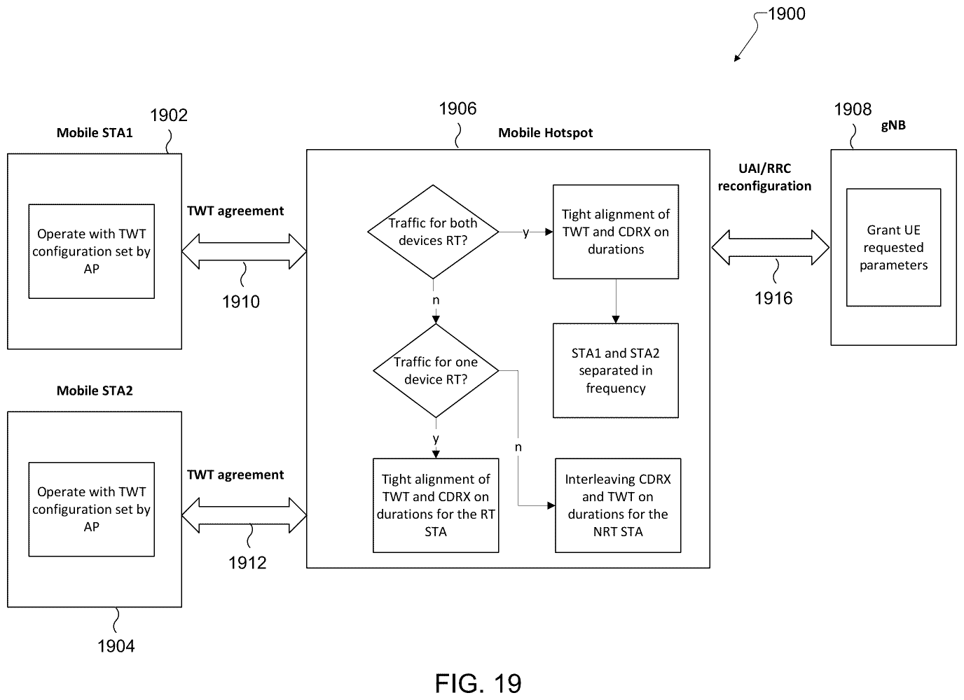

When there are multiple STAs connected to the AP, a naïve approach would be aligning the TWT wake duration of all the STAs with the CDRX ON duration. This, however, can result in contention between multiple STAs. An example implementation for two STAs is shown in FIG. 19.

FIG. 19 illustrates an example process 1900 for optimizing CDRX on duration and TWT target wake duration alignment. An embodiment of the process illustrated in FIG. 19 is for illustration only. One or more of the components illustrated in FIG. 19 may be implemented in specialized circuitry configured to perform the noted functions or one or more of the components may be implemented by one or more processors executing instructions to perform the noted functions. Other embodiments of optimizing CDRX on duration and TWT target wake duration alignment could be used without departing from the scope of this disclosure.

In the example of FIG. 19, a mobile hotspot 1906 is a UE with respect to a gNB 1908, and is serving as an AP for a first mobile STA 1902 and second mobile STA 1904. According to an embodiment of mobile hotspot AP dozing behavior, if a first TWT agreement 1910 is in place between mobile hotspot 1906 and mobile STA 1902 and a second TWT agreement 1912 is in place between mobile hotspot 1906 and mobile STA 1904, mobile STA 1902, mobile STA 1904, and mobile hotspot 1906 may save power by dozing based on the TWT agreements 1910 and 1912 similar as described regarding FIG. 12. Mobile hotspot 1906 may additionally save power by periodically turning off its cellular module through the CDRX operation. The parameters for CDRX operation are shared with gNB 1908 based on the UE assistance information (UAI) framework proposed in Release 16 of the 3GPP, illustrated in FIG. 19 as UAI/RRC reconfiguration 1916.

Though it is unlikely that a mobile AP is connected to a large number of STAs, the concepts from the example of FIG. 19 can be extended to a larger number of STAs. Specifically, traffic classification is performed for both STAs 1902 and 1904. The traffic classifier may operate on the mobile hotspot, conditionally on the mobile hotspot, or on the STAs similar as previously described herein. If the traffic for both devices is real time (RT), then a tight alignment between the CDRX ON duration and the wake duration of the TWT on both STAs 1902 and 1904 is maintained, and contention between STAs 1902 and 1904 is avoided by serving both STAs 1902 and 1904 on different frequencies. If, however, the traffic for one device is RT and the traffic for the other device is non-real time (NRT), then the STA with the RT traffic has a tight alignment of target wake duration with the CDRX ON duration, and the STA with the NRT traffic doesn't have a tight alignment since it can tolerate the delay. This way STA with RT traffic and the STA with NRT traffic do not suffer in QoS and there is also no contention for the channel. If the traffic for both STAs 1902 and 1904 is NRT, then the alignment does not matter, and it can be decided arbitrarily which STA will have the tight alignment.

Although FIG. 19 illustrates one example process 1900 for optimizing CDRX on duration and TWT target wake duration alignment, various changes may be made to FIG. 19. For example, while shown as a series of steps, various steps in FIG. 19 could overlap, occur in parallel, occur in a different order, or occur any number of times. It should be understood that while FIG. 19 illustrates a mobile hotspot 1906, mobile hotspot 1906 may also be referred to as a mobile AP.

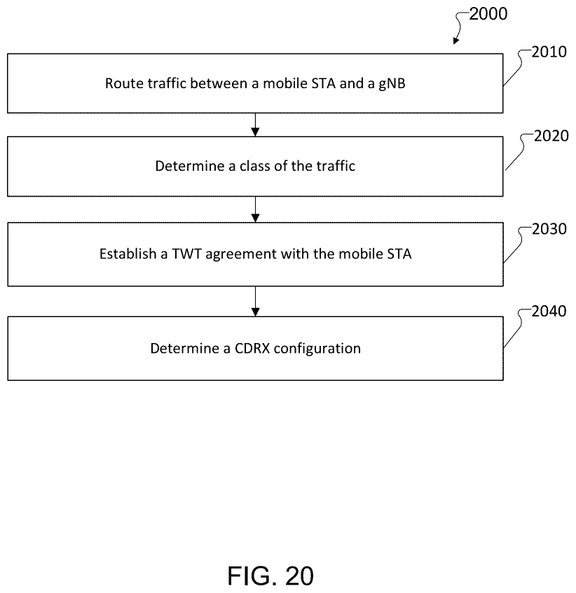

FIG. 20 illustrates a method 2000 for joint CDRX-TWT optimization for mobile hotspots according to embodiments of the present disclosure. An embodiment of the method illustrated in FIG. 20 is for illustration only. One or more of the components illustrated in FIG. 20 may be implemented in specialized circuitry configured to perform the noted functions or one or more of the components may be implemented by one or more processors executing instructions to perform the noted functions. Other embodiments of a method 2000 for joint CDRX-TWT optimization for mobile hotspots may be used without departing from the scope of this disclosure.

As illustrated in FIG. 20, the method 2000 begins at step 2010. At step 1010, a mobile hotspot routes traffic between a mobile STA and a gNB. At step 2020, the mobile hotspot determines a class of the traffic. The class of the traffic may be determined based on a traffic classification operation performed at the mobile hotspot, at the mobile STA, or both the mobile hotspot and the mobile STA. step 2030, the mobile hotspot establishes a TWT agreement with the mobile STA. The TWT agreement is based on the class of the traffic, and permits a first transceiver comprised by the mobile hotspot and configured to transmit and receive traffic with the mobile STA to doze Finally, at step 2040, the mobile hotspot determines a CDRX configuration. The CDRX configuration is for a second wireless transceiver comprised by the mobile AP and configured to transmit and receive traffic with the gNB.

Although FIG. 20 illustrates one example of a method 2000 for sleep detection with multiple sensors, various changes may be made to FIG. 20. For example, while shown as a series of steps, various steps in FIG. 20 could overlap, occur in parallel, occur in a different order, or occur any number of times. It should be understood that while FIG. 15 describes a method performed by a mobile hotspot, the mobile hotspot may also be referred to as a mobile AP.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A mobile access point (AP) comprising:
a first wireless transceiver configured to transmit and receive traffic with a first mobile station (STA);
a second wireless transceiver configured to transmit and receive traffic with a gNB; and
a processor operably coupled to the first wireless transceiver and the second wireless transceiver, the processor configured to:
route traffic between the first mobile STA and the gNB;
determine, based on a traffic classification operation, a class of the traffic;
establish, based on the class of the traffic, a Target Wake Time (TWT) agreement between the mobile AP and the first mobile STA, wherein the TWT agreement permits the first wireless transceiver to doze; and
determine, based on the class of the traffic, a continuous mode discontinuous reception (CDRX) configuration for the second wireless transceiver.

2. The mobile AP of claim 1, wherein the processor is further configured to:
determine a number of mobile STAs connected to the mobile AP; and
determine whether the mobile AP and the first mobile STA have a same vendor;
wherein the first wireless transceiver is permitted to doze based on:
a number of STAs connected to the mobile AP being below a threshold; and
the mobile AP and the first mobile STA having the same vendor.

3. The mobile AP of claim 1, wherein the traffic classification operation is performed by the mobile AP, and the processor is further configured to:
determine optimal TWT parameters, wherein the TWT agreement is based on the optimal TWT parameters; and
determine optimal CDRX parameters, wherein the CDRX configuration is based on the optimal CDRX parameters.

4. The mobile AP of claim 1, wherein:
the traffic classification operation is performed by the first mobile STA;
the first wireless transceiver is further configured to receive a predicted traffic class from the first mobile STA; and
the TWT agreement between the mobile AP and the first mobile STA is negotiated based on the predicted traffic class.

5. The mobile AP of claim 4, wherein the processor is further configured to:
determine that no traffic other than traffic associated with the mobile first STA will be routed between the mobile AP and the gNB;
determine optimal TWT parameters based on the predicted traffic class, wherein the TWT agreement is based on the optimal TWT parameters; and
determine optimal CDRX parameters based on the predicted traffic class, wherein the CDRX configuration is based on the optimal CDRX parameters.

6. The mobile AP of claim 4, wherein the processor is further configured to:
determine that traffic in addition to traffic associated with the first mobile STA will be routed between the mobile AP and the gNB;
perform a second traffic classification operation;
determine optimal TWT parameters based on a result of the second traffic classification operation and the predicted traffic class, wherein the TWT agreement is based on the optimal TWT parameters; and
determine optimal CDRX parameters based on the result of the second traffic classification operation and the predicted traffic class, wherein the CDRX configuration is based on the optimal CDRX parameters.

7. The mobile AP of claim 4, wherein the processor is further configured to:
determine that no traffic other than traffic associated with the first mobile STA will be routed between the mobile AP and the gNB;
perform a second traffic classification operation;
determine, based on the predicted traffic class and a result of the second traffic classification operation, a merged traffic class prediction;
determine optimal TWT parameters based on the merged traffic class prediction, wherein the TWT agreement is based on the optimal TWT parameters; and
determine optimal CDRX parameters based on the merged traffic class prediction, wherein the CDRX configuration is based on the optimal CDRX parameters.

8. The mobile AP of claim 1, wherein the processor is further configured to:
set a DRX inactivity timer to 0;
determine, based on the class of the traffic associated with the first mobile STA, an optimal CDRX cycle;
match a target wake interval associated with the TWT agreement to the determined optimal CDRX cycle; and
match a target wake duration associated with the TWT agreement to a CDRX on duration.

9. The mobile AP of claim 1, wherein the processor is further configured to:
determine, based on the class of the traffic associated with the first mobile STA, an optimal CDRX cycle and an optimal CDRX on duration;
match a target wake interval associated with the TWT agreement to the determined optimal CDRX cycle;
determine a CDRX sleep ratio based on:
the class of the traffic associated with the first mobile STA;
the determined CDRX cycle; and
the determined CDRX on duration; and
determine, a target wake duration with a doze ratio identical to the determined CDRX sleep ratio.

10. The mobile AP of claim 1, wherein:
the first wireless transceiver configured to transmit and receive traffic with a second mobile STA; and
the processor is further configured to:
determine whether traffic associated with the first mobile STA is real time (RT);
determine whether traffic associated with the second mobile STA is RT; and
establish a TWT agreement with the second mobile STA,
wherein:
if the traffic associated with the first and the second mobile STAs is RT, the processor is further configured to configure a tightly aligned TWT duration and CDRX duration;
if the traffic associated with one of the first or second mobile STA is RT, and the traffic associated with the other of the first or second mobile STA is non-RT (NRT), the processor is further configured to configure a tightly aligned TWT duration and CDRX duration for the one of the first or second mobile STAs associated with the RT traffic; and
if the traffic associated with the first and second mobile STAs is NRT, the processor is further configured to interleave the CDRX duration and TWT durations for the first and second mobile STAs.

11. A mobile station (STA) comprising:
a wireless transceiver configured to transmit and receive traffic with a mobile access point (AP); and
a processor operably coupled to the wireless transceiver, the processor configured to establish a Target Wake Time (TWT) agreement between the mobile STA and the mobile AP,
wherein the TWT agreement is established based on a class of traffic routed between the mobile STA and a gNB via the mobile AP, and
wherein the TWT agreement permits a second wireless transceiver comprised by the mobile AP and configured to transmit and receive traffic with the mobile STA to doze.

12. The mobile STA of claim 11, wherein the processor is further configured to:
determine whether the mobile STA and the mobile AP have a same vendor,
wherein the second wireless transceiver comprised by the mobile AP is permitted to doze based on the mobile AP and the mobile STA having the same vendor.

13. The mobile STA of claim 11, wherein the class of the traffic is determined based on a traffic classification operation performed by the mobile AP.

14. The mobile STA of claim 11, wherein:
the processor is further configured to:
perform a traffic classification operation; and
generate a predicted traffic class based on the traffic classification operation;
the wireless transceiver is further configured to transmit the predicted traffic class to the mobile AP; and
the TWT agreement between the mobile AP and the mobile STA is negotiated based on the predicted traffic class.

15. The mobile STA of claim 14, wherein:
the TWT agreement is based on optimal TWT parameters; and
the optimal TWT parameters are determined based on the predicted traffic class.

16. The mobile STA of claim 14, wherein:
the TWT agreement is based on optimal TWT parameters; and
the optimal TWT parameters are determined based on a result of a second traffic classification operation performed by the mobile AP.

17. The mobile STA of claim 14, wherein:
the TWT agreement is based on optimal TWT parameters; and
the optimal TWT parameters are determined based on the predicted traffic class and a result of a second traffic classification operation performed by the mobile AP.

18. A method of operating a mobile access point (AP), the method comprising:
routing traffic between a first mobile station (STA) and a gNB;
determining, based on a traffic classification operation, a class of the traffic;
establishing, based on the class of the traffic, a Target Wake Time (TWT) agreement between the mobile AP and the first mobile STA, wherein the TWT agreement permits a first wireless transceiver comprised by the mobile AP and configured to transmit and receive traffic with the mobile STA to doze; and
determining, based on the class of the traffic, a continuous mode discontinuous reception (CDRX) configuration for a second wireless transceiver comprised by the mobile AP and configured to transmit and receive traffic with the gNB.

19. The method of claim 18, further comprising:
determining a number of mobile STAs connected to the mobile AP; and
determining whether the mobile AP and the first mobile STA have a same vendor,
wherein the first wireless transceiver is permitted to doze based on:
the a number of STAs connected to the mobile AP being below a threshold; and
the mobile AP and the first mobile STA having the same vendor.

20. The method of claim 18, further comprising:
determining whether traffic associated with the first mobile STA is real time (RT);
determining whether traffic associated with a second mobile STA is RT; and
establishing a TWT agreement with the second mobile STA;
if the traffic associated with the first and the second mobile STAs is RT, configuring a tightly aligned TWT duration and CDRX duration;
if the traffic associated with one of the first or second mobile STA is RT, and the traffic associated with the other of the first or second mobile STA is non-RT (NRT), configuring a tightly aligned TWT duration and CDRX duration for the one of the first or second mobile STAs associated with the RT traffic; and
if the traffic associated with the first and second mobile STAs is NRT, interleaving the CDRX duration and TWT durations for the first and second mobile STAs.
